(19) United States
(12) Patent Application Publication
(10) Pub. No.: US 2012/0222116 A1
(43) Pub. Date: Aug. 30, 2012

(54) SYSTEM AND METHOD FOR DETECTING WEB BROWSER ATTACKS

(75) Inventor: Stephan Chenette, La Jolla, CA (US)

(73) Assignee: Websense, Inc., San Diego, CA (US)

(21) Appl. No.: 13/035,832

(22) Filed: Feb. 25, 2011

(51) Int. Cl. G06F 21/00; G06F 15/16; G06F 11/30

(52) U.S. Cl. 726/23

(57) ABSTRACT

A method and system for detecting a heap corruption exploit of a web browser is described. The method comprises installing or injecting a detection module into the web browser. Next, the detection module patches or hooks all calls to the detection module in order to identify calls indicating a heap corruption exploit. The identified calls are then analyzed to determine whether a heap corruption exploit is occurring.

### BACKGROUND OF THE INVENTION

1. Field of the Invention

Web browsers are used to access websites on the Internet. Typically, a user will access the website using the browser of the user's computer. Websites can contain a mix of active and static content. Active content performs an operation using the web browser, while static content is only viewed by the user. The code used to present the static or active content on the website can be used by attackers to gain access to the user's computer. In this regard, there are a large number of malicious websites on the Internet such that client-side vulnerabilities and especially web browser vulnerabilities are a concern.

2. Description of the Related Technology

One such attack is the heap corruption exploit of the web browser whereby shell code is placed onto the memory heap of the computer using a client scripting language such as JavaScript to allocate space. The exploit works by “spraying” or writing to the heap no operation instructions (NOPs) and payload using a browser supported language such as JavaScript, VBScript, etc . . . Next, the vulnerability is triggered to overwrite the heap headers and heap data to overwrite object and virtual function pointers. The end result is that the flow of execution gets redirected to the NOP data. The object or virtual table pointer being called redirects the flow of execution to the shell code that was sprayed onto the heap. The shell code can then cause the computer to perform a malicious or unwanted operation.

The heap exploit can fail for a variety of reasons such as if the machine has low memory or the heap state between triggering and exploit redirection has changed dramatically. Also if multiple exploits using the same heap spray address are used then the exploit can be unreliable. However, the heap exploit is a very dangerous vulnerability that can give attackers access to a user's machine.

Do to the dangerous nature of the heap corruption exploit, there is a need for a system and method to detect this exploit in order to ensure safe web browsing for users.

### SUMMARY

A method and system for detecting a heap corruption exploit of a web browser is described. The method comprises installing or injecting a detection module into the web browser. Next, the detection module patches or hooks all calls of the web browser to the heap memory to the detection module in order to identify calls indicating a heap corruption exploit. The identified calls are then analyzed to determine whether a heap corruption exploit is occurring.

Typically, the calls are identified by matching them to a predefined format that corresponds to a heap corruption exploit. It has been shown that calls in the format CALL DWORD PTR typically redirect operation to malicious operations. The calls are analyzed to determine whether a heap corruption exploit is occurring by determining whether execution of the code from the call causes a malicious operation to occur on the computer. The heap process memory can be analyzed and compared to standard characteristics of normal operation in order determine whether the call interrupts operation of the computer and is a malicious operation. If a heap corruption exploit is occurring, then the detection module can stop execution in order to prevent the exploit from occurring.

### BRIEF DESCRIPTION OF THE DRAWINGS

Description of the Drawings

FIG. 1 is a diagram showing a system for preventing a heap corruption attack.

FIG. 2 is a flowchart showing how to identify a heap corruption exploit.

### DETAILED DESCRIPTION OF CERTAIN INVENTIVE EMBODIMENTS

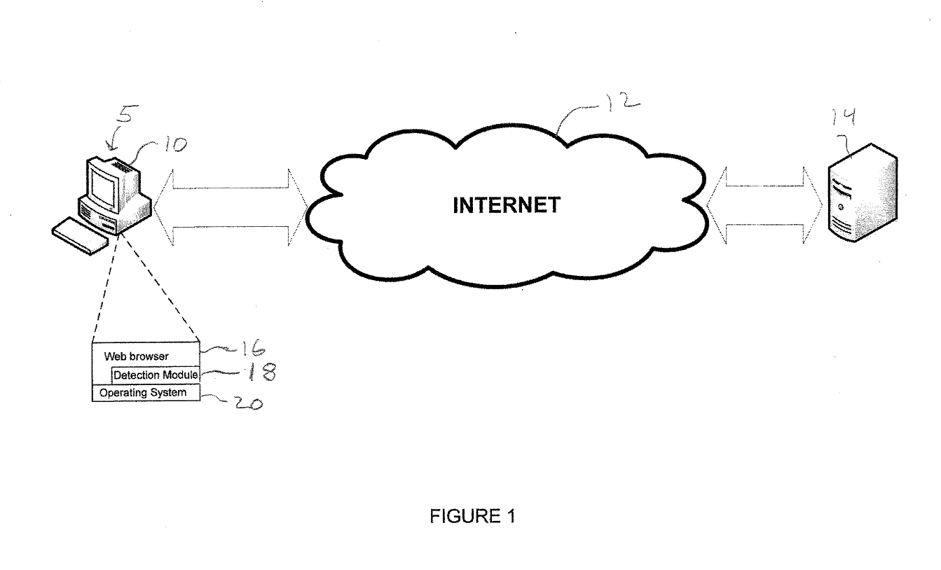

Referring to FIG. 1, a diagram showing the elements of a system 5 for preventing a heap corruption attacks is shown. The system 5 has a computer 10 for requesting web pages with a web browser 16. Specifically, the computer 10 is installed with an operating system 20 and web browser 16 (i.e., Internet Explorer, Firefox, etc . . . ) that a user operates to request and display web pages as is commonly known. The computer 10 is connected to a web server 14 or other type of electronic device that is capable of storing web pages through the Internet 12. As will be recognized by those of ordinary skill in the art, the configuration of the system 5 enables a user to request web pages with the computer 10 from the web server 14.

The system 5 identifies malicious code from the web pages retrieved from web server 14 from being executed on the computer 10. In some instances, web pages may include malicious code that executes a heap corruption attack. Code from the webpage sprays or writes the memory heap of computer 10 with malicious code in order to overwrite the memory pointer of the computer 10 and redirect execution to code that performs a malicious or unwanted operation. The execution is redirected by a call to an object or virtual function to redirect execution. In order to successfully execute the redirection, the call is typically in the format:

CALL DWORD PTR [reg+x]

where reg+x is the pointer to the virtual address table that was previously overwritten with the address of the attacker's shellcode on the heap during the heap corruption.

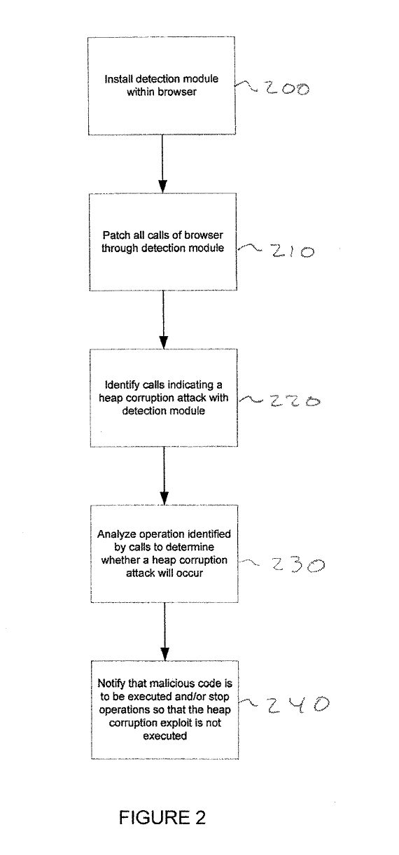

It is possible to identify and defend against the heap corruption attack by installing a detection module 18 within the web browser 16 of computer 10 to look for the specific call before execution. FIG. 2 is a flowchart illustrating a method of identifying and preventing heap corruption attacks with the system 5. In step 200, the detection module 18 is injected or installed into the web browser 16. For Internet Explorer, a process may be created that injects the detection module 18.

Next, in step 210, all calls of the browser are patched through the detection module 18. The patching is an ongoing process whereby calls are patched at start and as modules are dynamically loaded. The calls are patched to virtual functions for analysis.

In step 220, the detection module 18 identifies calls that may indicate a heap corruption attack. The detection module 18 identifies calls that match a predefined pattern known to cause heap corruption attacks. Specifically, the detection module locates calls in the format CALL DWORD PTR as these are known to redirect execution to the attacker's code.

Once a matching call has been identified, the operation of the computer 10 using the redirected execution is analyzed in step 230. The detection module 18 determines if the redirected execution from the call identified in step 220 is unwanted or malicious. The behavior of the computer 10 and hence the heap process memory is determined by comparing it to standard characteristics for normal operation or using other various factors that can indicate a malicious operation is to occur. For example, if page permissions look suspicious, then it can be assumed that the redirect from the call identified in step 220 is from a heap corruption attack and the resulting operation is malicious. Also, signature matching can be performed on the code to be executed from the call in order to determine whether it is malicious. In step 240, a notification is generated that malicious code is to be executed from a heap corruption attack and/or all operations can be stopped so that the heap corruption attack is not executed. In this way it is possible to identify a heap corruption exploit before it is executed.

In addition to the foregoing, it is also possible to use the method described in FIG. 2 to catch exploits that crash the computer 10. In this regard, structured exception handlers (SEH) are hooked in a similar manner as the calls from the web browser. When an exception occurs, the location of the exception handler is verified through the detection module and the resulting action can be analyzed and the user notified if a malicious action is to occur.

The various illustrative logical blocks, modules and circuits described in connection with the embodiments disclosed herein may be implemented or performed with a general purpose processor, a digital signal processor (DSP) an application specific integrated circuit (ASIC), a field programmable gate array (FPGA) or other programmable logic device, discrete gate or transistor logic, discrete hardware components or any combination thereof designed to perform the functions described herein. A general purpose processor may be a microprocessor, but in the alternative, the processor may by any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory EPROM memory, EEPROM memory, registers, hard disk, a removable disk, a CD-ROM, o any other form a storage medium known in the art. A storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

What is claimed is:

1. A method for detecting a heap corruption exploit of a web browser of a computer, the method comprising:
installing a detection module into the web browser;
using the detection module to patch all calls to the detection module;
identifying calls indicating a heap corruption exploit; and
analyzing the identified calls to determine whether a heap corruption exploit is occurring.

2. The method of claim 1 wherein the step of analyzing the identified calls further comprises determining whether execution of the call is being redirected to the heap.

3. The method of claim 1 wherein the step of identifying the calls indicating a heap corruption exploit comprises identifying calls that correspond to a predefined format.

4. The method of claim 3 wherein the predefined format comprises the command CALL DWORD PTR.

5. The method of claim 1 wherein the step of analyzing the identified calls further comprises analyzing the heap process memory to determine whether the call interrupts operation.

6. The method of claim 5 wherein the step of analyzing the heap process memory comprises comparing the memory to standard characteristics for normal operation.

7. The method of claim 1 wherein execution of the call can be stopped if a heap corruption exploit is occurring.

8. A system for detecting a heap corruption exploit of a web browser application, the system comprising:
a computer running the web browser application; and
a detection module installed within the web browser application, the detection module configured to patch all calls of the web browser to the detection module and indentify calls indicating a heap corruption exploit, the detection module further configured to analyze the identified calls and determine whether a heap corruption exploit is occurring.

9. The system of claim 8 wherein the detection module is configured to determine whether the execution of the call is being redirected to the heap.

10. The system of claim 8 wherein the detection module is configured to identify calls indicating a heap corruption exploit by identifying calls that correspond to a predefined format.

11. The system of claim 10 wherein the predefined format comprises the command CALL DWORD PTR.

12. The system of claim 8 wherein the detection module is configured to analyze heap process memory to determine whether the call interrupts operation.

13. The system of claim 12 wherein the detection module is configured to analyze the heap process memory by comparing the memory to standard characteristics for normal operation.

14. The system of claim 8 wherein the detection module is configured to stop execution of the call if a heap corruption exploit is occurring.
